(19) United States
(12) Patent Application Publication
(10) Pub. No.: US 2009/0265452 A1
(43) Pub. Date: Oct. 22, 2009

(54) APPARATUS, METHOD, AND COMPUTER PROGRAM PRODUCT FOR CHARACTERIZING USER-DEFINED AREAS

(76) Inventors: David M. Balaishis, Woodland Hills, CA (US); Vasil Nadzakov, Los Angeles, CA (US); Robert Allan Meyer, Calabasas, CA (US); Joe DeTuno, Thousand Oaks, CA (US); Ashley Woodworth, Malibu, CA (US); Jack Dennison, Austin, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/495,333

(22) Filed: Jun. 30, 2009

Related U.S. Application Data
(63) Continuation of application No. 12/268,738, filed on Nov. 11, 2008.
(60) Provisional application No. 60/987,157, filed on Nov. 12, 2007.

(51) Int. Cl. G06F 15/177

(52) U.S. Cl. 709/221

(57) ABSTRACT

A method of specifying a boundary for an area is provided, which includes receiving a first input from a first user regarding a first configuration of a boundary of an area. The first input may serve to establish an area of arbitrary and possibly irregular configuration, such as an area that is apolitical or otherwise legally undetermined. A second input may be received from a second user regarding a second boundary configuration. The second input may serve to modify the boundary of an area established by the first input. A particular configuration of the boundary based at least partially on the first and second inputs can then be determined. For example, the particular configuration of the boundary may be determined, in part, by spatially averaging the first and second configurations. In some embodiments, demographic data for an area defined by the particular configuration of the boundary may be compiled.

### CROSS-REFERENCE TO RELATED APPLICATION

The present application is a continuation of U.S. patent application Ser. No. No. 12/268,738 filed on Nov. 11, 2008, which claims the benefit of U.S. Provisional Patent Application No. 60/987,157 filed on Nov. 12, 2007, the contents of both of which are incorporated herein by reference in their respective entireties.

### FIELD OF APPLICATION

Embodiments of the present invention relate generally to methods and computer program products for characterizing areas, and more particularly to methods and computer program products for creating and/or characterizing user-defined areas.

### BACKGROUND

In various situations, it may be desirable to gather data regarding a certain geographic area. For example, persons interested in relocating or purchasing a new home may be interested in learning about the demographics and home prices in a certain locality or region. Persons purchasing real estate may want to know the nature of an area of land. Those considering launching a business may be interested in traffic patterns and crime rates.

Regardless of the underlying motivation, it would be helpful to have access to information characterizing an area or neighborhood. To this end, it is common to utilize network research tools to gather information about areas of interest (e.g., particular geographic areas). However, while these tools can be useful, they typically do not allow for the collection of data pertaining to non-standard or customized areas that do not correspond to designated political or otherwise legally-defined boundaries or already widely-recognized neighborhoods. Further, existing research tools generally fail to effectively take advantage of one potentially helpful resource, that being the collective input from a significant number of persons having first-hand experience regarding an area, especially a non-standard area.

### SUMMARY

In one aspect, a method of specifying a boundary for an area is provided. The method includes receiving a first input from a first user regarding a first configuration of a boundary of an area. For example, a graphical geographic representation may be presented, and the first input can specify a first configuration of a boundary of a geographic area relative to the graphical geographic representation. The first input may serve to establish an area of arbitrary and possibly irregular configuration, such as an area that is apolitical or otherwise legally undetermined.

A second input may be received from a second user regarding a second configuration of the boundary, for example, by specifying a second configuration of the boundary relative to the graphical geographic representation. The second input may serve to modify the boundary of an area established by the first input. For example, the first configuration of the boundary can be stored and graphically presented, e.g., via a web browser, prior to receiving the second input regarding the second configuration of the boundary. The first and second configurations of the boundary may be graphically presented in a graphical geographic representation, such as relative to a geographic map provided via a web browser, so as to allow comparison therebetween.

A particular configuration of the boundary based at least partially on the first and second inputs can then be determined. For example, the particular configuration of the boundary may be determined, in part, by spatially averaging the first and second configurations. The particular configuration of the boundary can be graphically presented in a graphical geographic representation, such as relative to a geographic map provided via a web browser. Once a particular configuration of the boundary has been determined, data characterizing the area defined by the particular configuration can be automatically compiled.

In some embodiments, receiving the second input regarding the second configuration of the boundary may include respectively receiving multiple inputs from multiple users. Each respective input would correspond to a respective configuration of the boundary. Determining the particular configuration of the boundary could then include iteratively determining a particular configuration of the boundary based at least partially on each subsequently received input and any previously received inputs.

In another aspect, a computer-readable storage medium is provided, which computer-readable storage medium stores computer-readable instructions that, when executed by a computer, cause the computer to carry out a method. The method includes receiving a first input from a first user regarding a first configuration of a boundary of an area. For example, the computer may present a graphical geographic representation, and a first input may be received from a first user specifying a first configuration of a boundary of a geographic area relative to the graphical geographic representation. A second input may be received from a second user regarding a second configuration of the boundary, for example, by specifying the second configuration of the boundary relative to the graphical geographic representation. A particular configuration of the boundary can be determined based at least partially on the first and second inputs.

In yet another aspect, a method of characterizing an area is provided. The method includes identifying an area of arbitrary configuration based on user input creating a boundary of the area. For example, a graphical geographic representation can be presented, and receiving user input may be received that specifies an arbitrary boundary of a geographic area relative to the graphical geographic representation. In response to identifying the area, data characterizing non-geometric aspects of the area (e.g., media, images, and/or demographic data, such as population, household occupant descriptions, information regarding income levels of the residents, cost of living, employment data, interests of area residents, lifestyle profiles, school information, crime indices, average mortgage balance, ethnicity, average age of the residents, and/or longevity of existing local businesses) can be automatically providing.

The demographic data characterizing the area may be automatically compiled by one or more of collecting data from a user, searching a pre-established database, and performing a web crawling operation. In some embodiments, a representation of the area may be stored. An indicator of the area can then be presented for selection, the indicator being based on the stored representation of the area. In response to receiving selection of the indicator of the area, demographic data characterizing the area can be automatically recompiled. For example, the area may be created based on user input from a first user, and demographic data characterizing the area may be automatically recompiled in response to receiving selection of the indicator of the area from a second user.

In still another aspect, a computer-readable storage medium is provided, which computer-readable storage medium stores computer-readable instructions that, when executed by a computer, cause the computer to carry out a method. The method includes identifying an area of arbitrary configuration based on user input creating a boundary of the area. In response to identifying the area, data characterizing non-geometric aspects of the area can be automatically provided.

In yet another aspect, a method of characterizing real estate data for an area is provided. The method includes creating an area of arbitrary configuration based on user input specifying a boundary of the area. In response to creating the area, real estate market data specific to the area can be automatically compiled. The real estate market data can be, for example, dwellings for sale, dwellings for rent, average home prices, average rental prices, average dwelling prices per square foot, average cost of living, percentage of owner occupied dwellings, percentage of renter occupied dwellings, median years in residence, median dwelling age, annual residential turnover, time on market, estimated dwelling value, valuation trends, and/or average household income.

In still another aspect, a computer-readable storage medium is provided, which computer-readable storage medium stores computer-readable instructions that, when executed by a computer, cause the computer to carry out a method. The method includes creating an area of arbitrary configuration based on user input specifying a boundary of the area. In response to creating the area, real estate market data specific to the area may be automatically compiled.

In yet another aspect, a method of conducting a discussion is provided. The method includes creating an area of arbitrary configuration based on user input specifying a boundary of the area. Input may be received from a first user establishing and regarding an arbitrary topic pertaining to the area. A second user may then provide input regarding the arbitrary topic. In some embodiments, data regarding the area, such as real estate data and/or demographic data, may be automatically compiled. In other embodiments, a third user may specify a boundary of the area, thereby establishing the area.

In still another aspect, a computer-readable storage medium is provided, which computer-readable storage medium stores computer-readable instructions that, when executed by a computer, cause the computer to carry out a method. The method includes creating an area of arbitrary configuration based on user input specifying a boundary of the area. Input establishing and regarding an arbitrary topic pertaining to the area may be received from a first user. Input regarding the arbitrary topic may then be received from a second user.

In other aspects, apparatuses for carrying out the above discussed methods are also provided. Each apparatus includes a processing device, which processing device can be configured to execute one or more of the above methods.

### BRIEF DESCRIPTION OF THE SEVERAL VIEWS OF THE DRAWING(S)

Reference will now be made to the accompanying drawings, which are not necessarily drawn to scale.

FIGS. 1 and 2 are schematic representations of outputs of an area characterization system configured in accordance with an exemplary embodiment.

FIG. 3 is a block diagram schematically representing an area characterization system configured in accordance with an exemplary embodiment.

FIGS. 4-6 are schematic representations of outputs of an area characterization system configured in accordance with an exemplary embodiment, the outputs including identified areas of interest and characterizing data associated therewith and being of varying magnification.

FIG. 7 is a schematic representation of an output of an area characterization system configured in accordance with an exemplary embodiment, the output including a graphical display showing multiple named and numbered areas of interest.

FIG. 8 is a schematic representation of an output of an area characterization system configured in accordance with an exemplary embodiment, the output including a textual display describing multiple named and numbered areas of interest.

FIG. 9 is a schematic representation of an output of an area characterization system configured in accordance with an exemplary embodiment, the output including a graphical display of city-level magnification and showing an area of interest (i.e., a geographic area) and characterizing data associated therewith.

FIGS. 10-12 are block diagrams schematically representing exemplary embodiments of an area characterization system.

FIG. 13 is a flowchart representing the operation of a method configured in accordance with an exemplary embodiment.

FIGS. 14-31 are outputs produced during the operation of an area characterization system configured in accordance with an exemplary embodiment.

FIGS. 32-34 are schematic representations of outputs of an area characterization system configured in accordance with a further exemplary embodiment.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present disclosure is generally directed to area characterization methods and computer program products, as well as systems configured to execute such methods and computer program products. Embodiments of such area characterization systems can be configured to allow a user to identify an arbitrary (geographic) area, and thereby identify the area, for example, as a distinctive neighborhood that might not have previously been well-recognized as such. The area may or may not be regularly bounded and/or continuous. Data concerning the identified area can then be aggregated and reported.

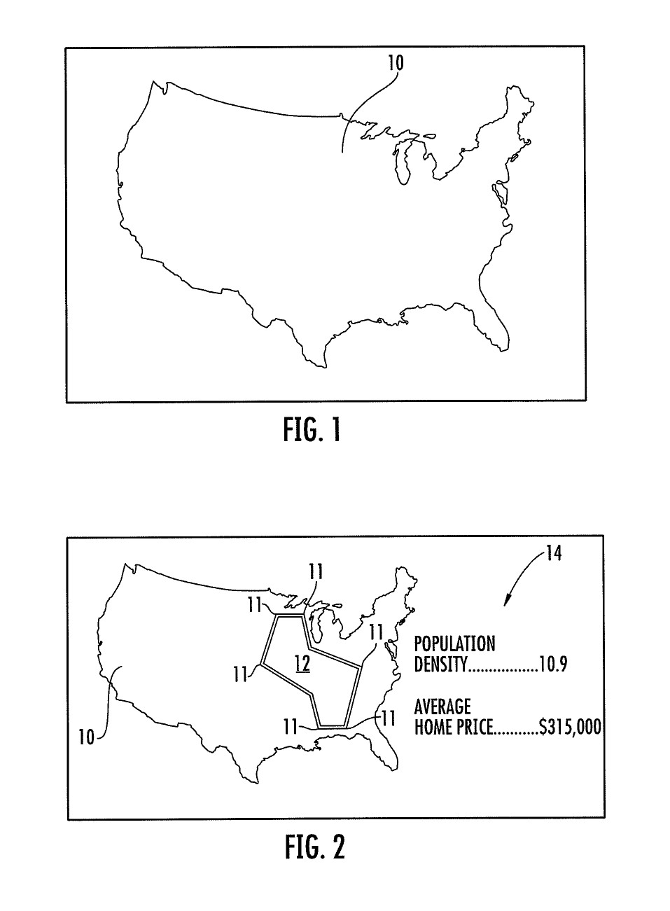

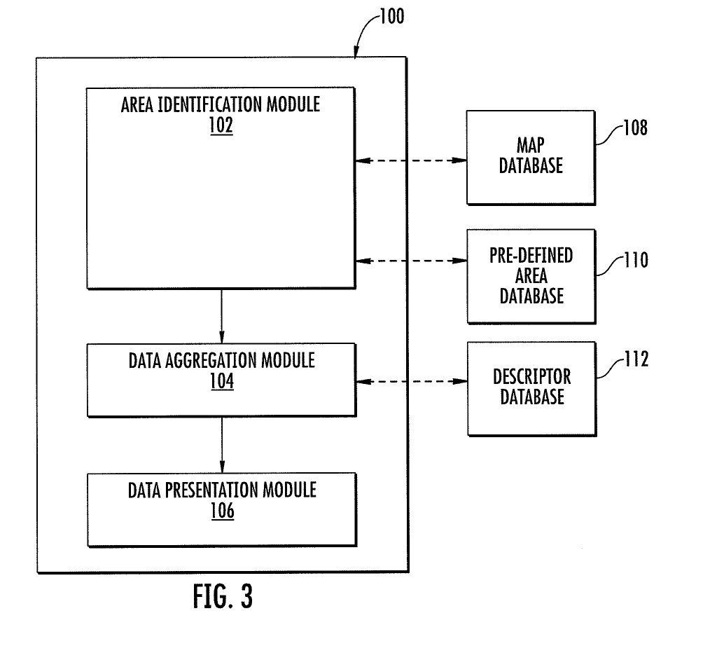

For example, as schematically illustrated in FIG. 1, an embodiment of an area characterization system may begin by presenting a graphical geographic representation, such as a map or other graphical display of a geographic region 10. Within this displayed region, an area 12 can be identified. For example, a user may provide input (such as via a pointing device) regarding a configuration of a boundary 11 of the area 12. The area 12 can be an arbitrary area as specified by the user. As shown in FIG. 2, following the identification of the area 12, the system can present data 14 that pertains to and/or characterizes the identified area and/or aspects thereof. Further, the area characterization system may allow for information related to this identified area to be accessed and possibly modified by other users. The composition and operation of embodiments of the area characterization system are described below in further detail.

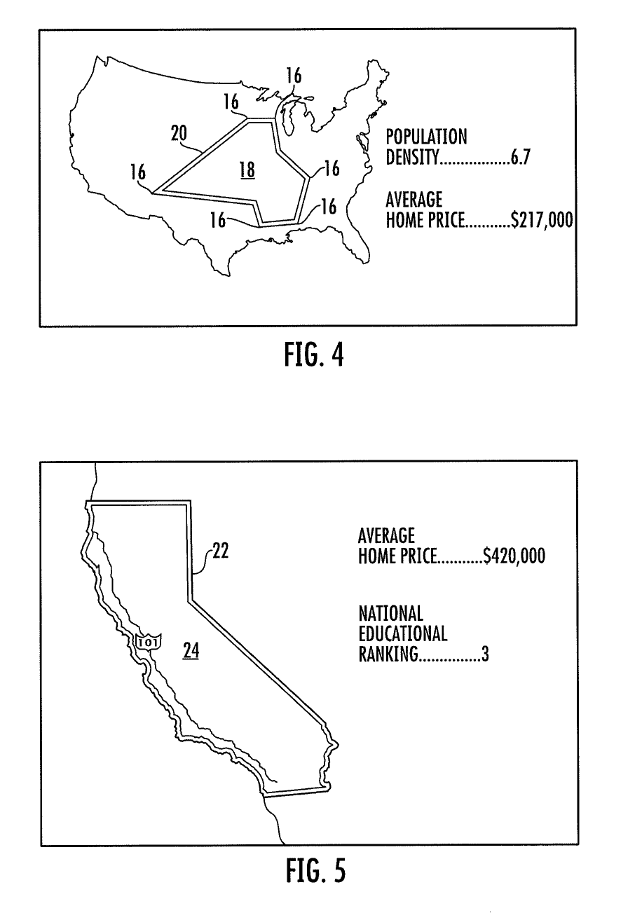

Referring to FIG. 3, therein is shown a block diagram schematically representing an area characterization system 100 configured in accordance with an exemplary embodiment. The system 100 can include an area identification module 102, a data aggregation module 104, and a data presentation module 106. The area identification module 102 can be configured to facilitate the designation of an area that is to be characterized. For example, considering the outputs represented by FIGS. 1 and 2, the area identification module 102 may prompt display of the region 10 and facilitate the identification therein of the area 12.

Referring to FIGS. 3-6, the area identification module 102 can be configured in a variety of ways to enable the identification of an area that is intended to be identified (or an “area of interest”). For example, the area identification module 102 may include or have access to a database of geographical maps (a “map database”) 108 (FIG. 3) that can be selectively magnified and/or de-magnified, in conjunction with which areas of interest can be located and identified. The geographical maps can be raster maps associated with vector data or completely generated from underlying vector data. In either case, the maps can mathematically identify each location within the map, for example, with vector coordinates. Vector data may also be provided for political boundaries, such as town, county, and state boundaries, for or otherwise legally-determined boundaries, such as boundaries between individually-owned properties, and for natural and man made landmarks, such as mountains, rivers, roads, and schools.

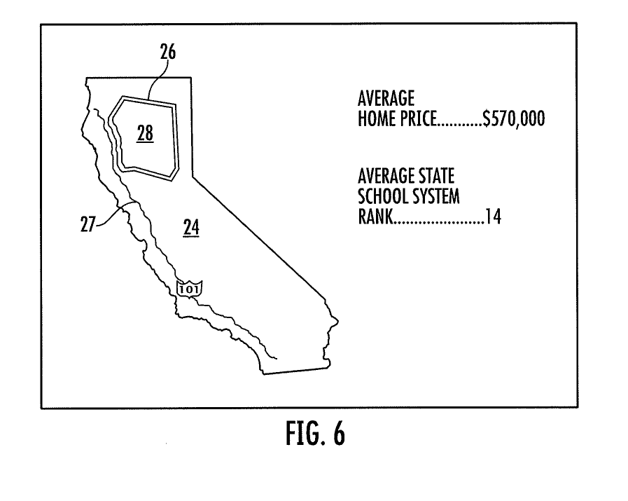

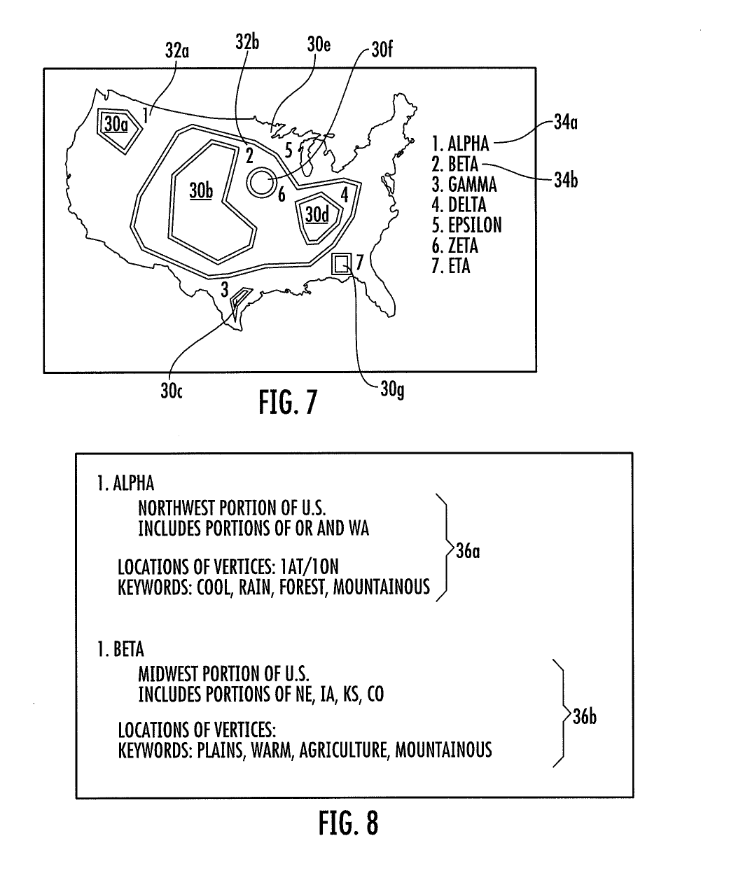

In embodiments where the area identification module 102 presents map data graphically, a user may designate or establish an area by specifying a configuration of the boundary of the area, for example, by specifying (e.g., with a pointing device) a series of vertices 16 that can be connected to form a boundary 20 that defines an area 18, such as a polygonal area. For example, the vertices 16 may be connected in the order in which they are identified, in a manner dictated by a formula (e.g., one that minimizes the curvature of the boundary 20 of the area 18), in an order specified by the user, etc. In other embodiments, a user may be able to specify or “draw” continuous (or near-continuous, as the case may be for a digital system) boundaries, or may be able to specify that areas should take on a standard geometric shape (e.g., by specifying that an area should form a circle centered at a certain location and with a given radius). In yet other embodiments, a user may select existing features in a map to act as the boundaries of an area intended to be identified, such as by selecting the boundary 22 of a state to form an area 24 (e.g., as in FIG. 5), or may select existing features in a map to act as the boundaries of an area, such as by selecting a highway 27 of a state to form part of the boundary 26 of an area 28 (e.g., as in FIG. 6). Alternatively, a user may select political boundaries (e.g., town or municipality lines) or portions thereof, subdivisions, or currently well-recognized apolitical or otherwise legally undetermined neighborhoods (like SoHo in New York City's borough of Manhattan). In still other embodiments, the area identification module 102 may allow for a combination of area identification techniques, such as a combination of vertex identification and feature identification (highway 27) in creating a boundary 26 of an area 28. A user may be able to indicate that specified vertices or curves should conform or “snap” to selectable landmarks.

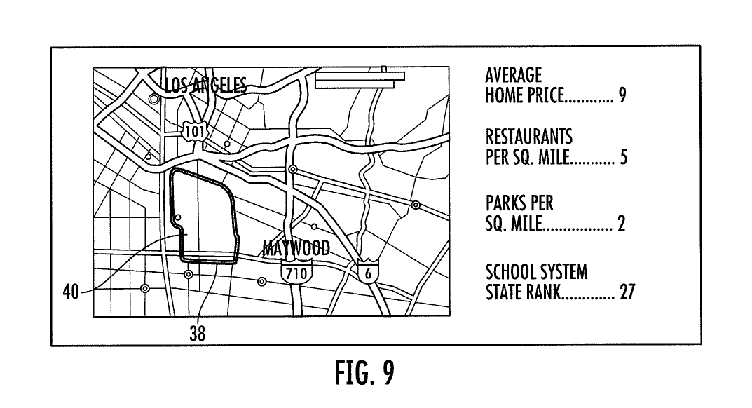

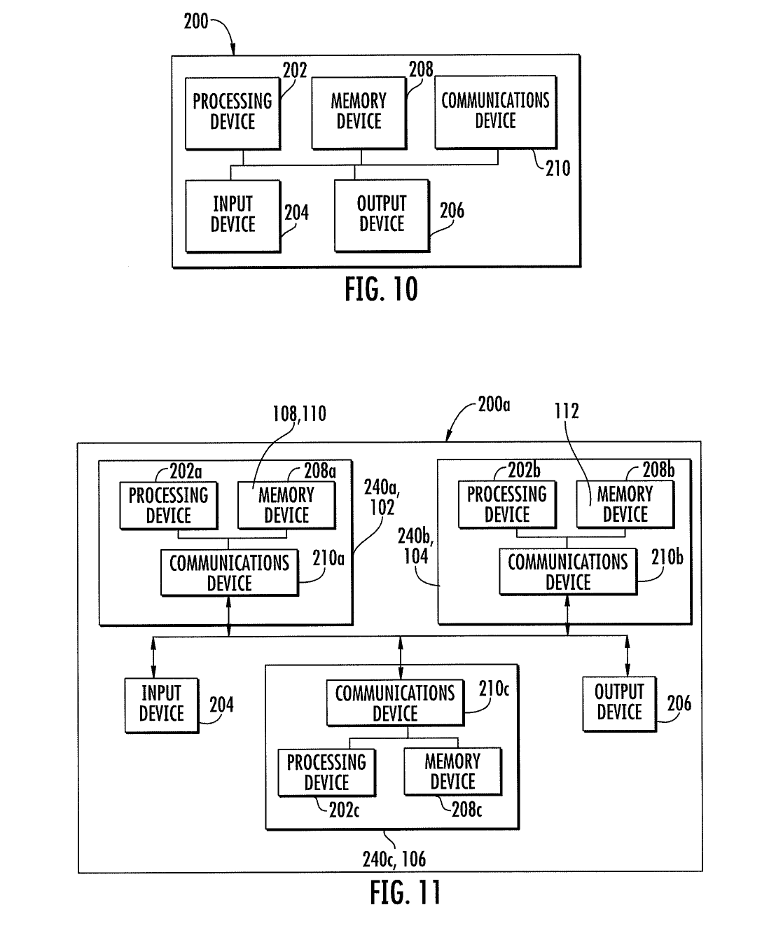

In some embodiments, the manner in which an area may be identified may be a function of the type and magnification of the associated graphical display. For example, when using landmarks to specify the boundary of an area of interest (e.g., a particular geographic area), the types of landmarks that are available for selection, either by default or at all, may depend on the level of magnification of the associated graphical display. For example, when using a town-level magnification (i.e., a graphical user interface sized to fit therein all or a portion of a town), local roads may serve as selectable landmarks (e.g., as in FIG. 9). By contrast, when using a state-level magnification, perhaps only highways may be displayed and available for selection as landmarks (e.g., as in FIG. 5). Employing such a strategy may avoid excessively cluttering of the display area.

Alternatively, referring to FIGS. 3, 7, and 8, the area identification module 102 may indicate one or more pre-defined areas 30a-g that may be selected by a user in order to designate an area of current interest. The pre-defined areas may be, for example, areas that were previously created by a user that is the same as or different from the present user. The area identification module 102 may allow a user to selectively display the pre-defined areas 30a-g, and/or to create new areas that can be added to a database of existing pre-defined areas (a “pre-defined area database”) 110 that is in communication with the area identification module. Each of the pre-defined areas 30a-g may be associated, for example, with an identifier 32a-g and/or a name 34a-g, which may be displayed to a user to facilitate user selection, along with a mathematical description of the spatial extent of the area, which may be maintained in the background so that a user is not presented with such information.

The pre-defined area database 110 can be searchable, such that the keywords or other information associated with each area can be used to find an area of interest (e.g., a particular geographic area that has been previously identified and is presently desired). Information 36a-b regarding each pre-defined area 30a-g may be presented either together with a graphical presentation of the pre-defined areas themselves or on a separate screen, this information possibly serving to facilitate area identification. For example, such information 36a-b can include geographic location information (such as latitude and longitude of the vertices defining the area), area descriptions (e.g., “pacific northwest U.S.” or “Chinatown”), keywords associated with an area, etc.

In some embodiments, the area identification module 102 may not provide any graphical presentation at all, but instead could provide a fully textual user interface. For example, the area identification module 102 could present a list of pre-defined areas, such as the information of FIG. 8, to a user, which could be utilized in identifying a pre-defined area for subsequent characterization. In other embodiments, a user could specify textually the vertices of an area intended to be identified (or an “area of interest”), for example, by entering the latitude and longitude of the vertices. In some embodiments, the area identification module 102 may combine a graphical and a text-based interface.

In some embodiments, the list of pre-defined areas can be made accessible to multiple users. For example, the list of pre-defined areas can be stored in a publicly-accessible web page or database. Alternatively, the listing of pre-defined areas can be contained in a private or semi-private location, such as, for example, a password-protected web page.

In other embodiments, previously defined or established areas may be stored and subsequently modifiable, either by the original creator or by others (if the area is made accessible to others), or both. For example, a previously defined and stored area configuration may be graphically presented (for example, as part of a graphical user interface provided via a web browser) for consideration and modification by subsequent users. In some cases, appropriate locations or configurations for area boundaries may be disputed, and such boundaries can be, for example, noted as disputed or can be placed at locations that amount to averaged (e.g., spatially averaged) suggestions by multiple users, or placed at locations representative of the weighted average based on other factors such as a user-based integrity factor, age of submission, or proportion of relationship to the region of non dispute or consensus.

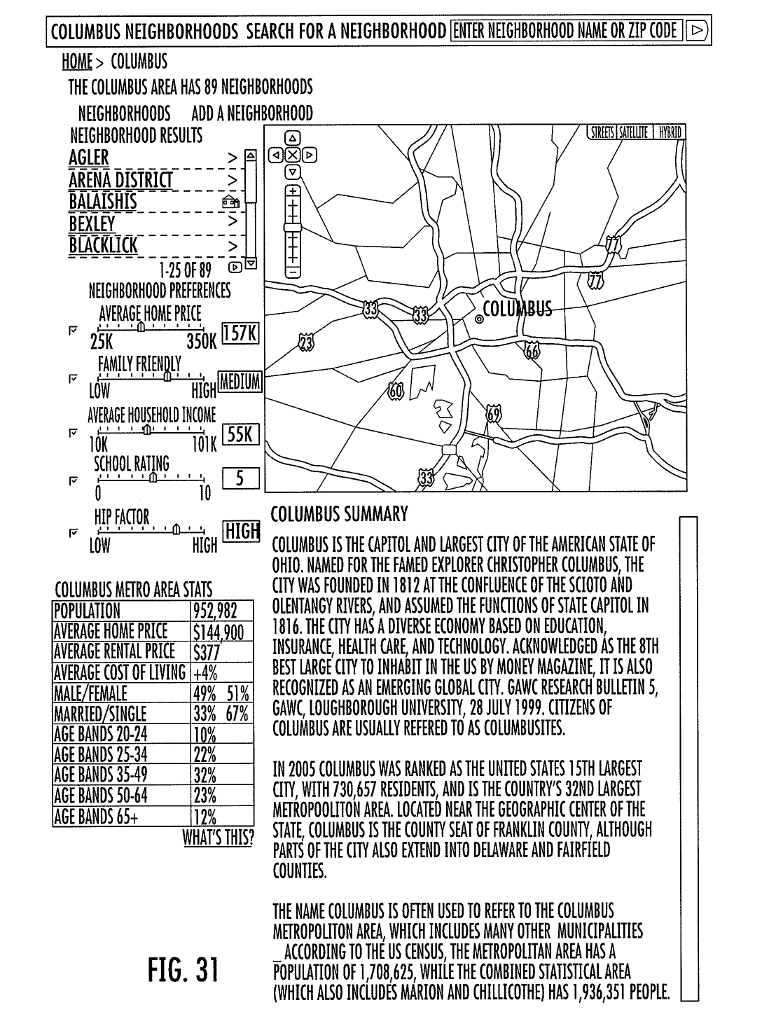

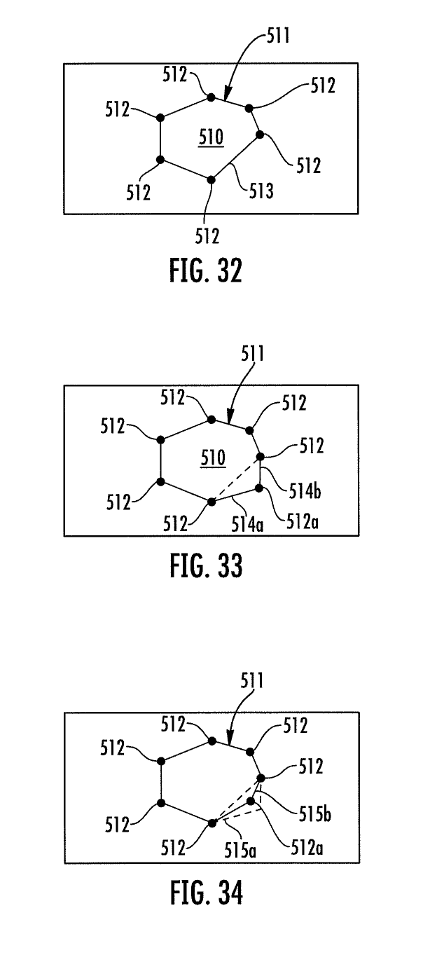

For example, referring to FIGS. 32-34, a first user may provide a first input regarding a first configuration (e.g., as shown in FIG. 32) of a boundary 511 of an area 510. The first user may, for example, create or establish the area 510 by selecting the vertices 512 within a graphical geographic representation (such as a map). Subsequently, a second user may provide a second input regarding a second configuration of the boundary 511 (e.g., as shown in FIG. 33). For instance, the second user may indicate that the area 510, as specified by the first user, should be modified, such as by including the vertex 512a and thereby defining the boundary 511 by the sides 514a and 514b. A particular configuration for the boundary 511 (e.g., as shown in FIG. 34) could then be determined from the first and second inputs, for example, by spatially averaging the position of the vertex 512a between those for the first and second configurations, so as to result in the boundary defined by the sides 515a and 515b.

Thereafter, a third user could provide a third input regarding a third configuration, which may or may not be consistent with either of the first and second configurations. The particular configuration could then be determined by spatially averaging all of the specified configurations (i.e., the first, second, and third configurations). In some embodiments, the third user may be graphically presented with the first and second configurations (e.g., in a web browser), such that the first and second configurations might be compared to one another by the third user.

Regardless of the manner in which an area of interest is identified (i.e., either selected or created), the area identification module 102 can determine the boundary (or boundaries) associated with the identified area and the points lying within or on the boundary or boundaries. Referring again to FIG. 3, the area identification module 102 can be in communication with the data aggregation module 104. The data aggregation module 104 can receive from the area identification module 102 the information specifying (perhaps mathematically using, say, latitude and longitude) the identified area and the locations that are and are not a part of the identified area.

The data aggregation module 104 can act to collect, perhaps automatically, information pertaining to the identified area. For example, the data aggregation module 104 can be in communication with a database (a “descriptor database”) 112 containing various sets of data that serve to describe aspects of a location. Each data set contained in the descriptor database 112 can be associated with one or more indications of the geographical location (each being a “geographical indicator”) to which the data set pertains (i.e., each data set contained in the descriptor database can be “geo-tagged”). For example, a data set may relate to the population of a city block, defined by four surrounding streets (e.g., the median annual income of the residents of the city block). A possible indication of geographic location in this case could be curves described in spherical coordinates aligned with the surface of the earth that serve to define the boundary of the block, and another could be the latitude and longitude of the four street intersections from which the block boundaries could be calculated, while still another could be the street addresses associated with properties located within the block. The median annual income data set could then be associated in the descriptor database 112, say, with a latitude/longitude that falls within the city block. Various types of data may be used to characterize an area, as discussed further below. It is noted that some types of data (e.g., street address) may act as both descriptive data and as a geographic indicator.

The descriptor database 112 can be populated with data sets in a variety of ways. For example, users can manually enter information into the descriptor database 112, e.g., either arbitrarily (i.e., at the user's discretion) and concerning topics of discretionary choice by a user or in response to being prompted by the data aggregation module 104. Users may also edit or supplement information already present in the descriptor database (e.g., information entered manually by a previous user). For example, the data aggregation module 104 may prompt a user to input descriptive information about an area's character and characteristics, and in cases where the area is newly-created, perhaps a name or other identifier. The data aggregation module 104 may also prompt a user to input location data to be associated with the descriptive data, and/or such data can be inferred from the identified area in conjunction with which the data is being entered. Alternatively, the descriptor database 112 can be automatically populated, for example, through connection, perhaps via a network, to other databases that include data sets associated with geographical indicators and subsequent extraction of the data sets and associated geographical indicators.

In some embodiments, the data aggregation module 104 can be configured to perform a web crawling activity over the Internet in order to identify location specific data sets. Such web crawling can be done instead of, or in addition to, searching and/or populating the descriptor database 112, or may be done in order to populate the descriptor database. For example, a web document or site may provide a description of a restaurant located at a specific address (the address being a geographic indicator). The data aggregation module 104 may be configured to locate such a web site and to extract from the site (e.g., from the metadata associated with the web site) restaurant address and description information. The address could then be converted to a more general form of location indication, such as latitude and longitude (another form of geographic indicator), and the geo-tagged data could be presented to a user. Alternatively, the web site metadata may include latitude and longitude information for the restaurant. The data aggregation module 104 could perform such a web crawling operation each time an area of interest is identified or periodically. The data sets collected during such web crawling could be presented directly to a user, or could be used to populate and/or supplement the descriptor database 112. Alternatively, some embodiments need not include a descriptor database at all.

The data aggregation module 104 can use geographical indicators to determine which data sets, for example, in the descriptor database 112, are associated with one or more identified areas. For example, the data aggregation module 104 can associate an identified area with known data (e.g., known demographic data) relating to aspects of the environment within the identified area's boundaries (e.g., homes for sale, schools, restaurants, theatres, parks, local businesses, and other points of interest, median household income, average mortgage balance, ethnicity, average age of the residents, longevity of existing local businesses, etc.). Other possible data that could be collected by the data aggregation module 104 includes: pictures of the identified area (generated by the user and/or by another), weather information (e.g., historical climate data such as monthly average temperatures, a weather index characterizing nature risks, and a pollution index), demographic data (e.g., population, household aspects, income information, cost of living, and employment data), setting and lifestyle data (e.g., ratings regarding “hip factor” and family friendliness, setting types, and lifestyle profiles), real estate listings (e.g., dwellings for sale and/or rent), housing data and maps (e.g., average home price, average rental price, average price per square foot, average cost of living, owner occupied dwellings, renter occupied dwellings, median years in residence, median dwelling age, annual residential turnover, and average household income), school information, and crime indices.

The data pertaining to specific areas of interest (e.g., particular geographic areas) can be, for example, temporarily separated into one or more separate databases associated with the identified area(s), or into separate portions of the descriptor database 112, or, to take another example, can be marked or identified as being associated with the identified area(s). In any event, these data sets together serve to characterize the identified area(s) to various degrees.

The data aggregation module 104 can be in communication with the data presentation module 106. The data presentation module 106 can present to a user the data sets collected by the data aggregation module 104 and pertaining to an identified area. The data presentation module 106 can be configured to summarize, prioritize, integrate, etc. the data collected by the data aggregation module 104 in a variety of ways that may be selectable and/or adjustable by a user.

For example, referring to FIGS. 5, 6, and 9, the data presentation module 106 can be configured such that the data that is primarily presented in conjunction with an identified area can be a function of the relative size of the area. Where the area boundary 22 corresponds to the boundary of a state, the data presented to a user can include an “Average Home Price” and a “National Educational Ranking,” as shown in FIG. 5. Alternatively, where the area boundary 26 corresponds to an area 28 consisting of several towns/counties, the data presented to a user can include an “Average Home Price” and an “Average State School System Rank,” as in FIG. 6. Finally, where the boundary 38 defines an area 40 that is contained within a town or city, the data presented to a user can include an “Average Home Price,” the “Restaurants Per Square Mile,” the “Parks Per Square Mile,” and the “School System State Rank,” as in FIG. 9.

It is noted that the data presentation module 106 may be configured to do at least any or all of the following with respect to the data sets associated with an identified area: report the data; distill the data; perform calculations based thereon (e.g., calculate demographic data observations about the identified area such as the average home value, the average household income level, the average resident longevity in the area, etc.); and summarize the data. As such, the data presentation module 106 is not necessarily limited to simply reporting collected data without any processing. Any data presented by the data presentation module may be provided in a variety of manners, including, for example, graphically (e.g., via a map, graph, and/or other information charts), textually, or otherwise, and combinations of different data presentation methods can be employed.

Referring to FIG. 10, therein is shown a block diagram representing an exemplary embodiment of an area characterization system 200. The system 200 can include at least one processing device 202, an input device 204, an output device 206, and at least one memory device 208, all, or any combination, of which may be in communication with one another. The processing device 202 can be, for example, a microprocessor, an application specific integrated circuit (ASIC), and/or any other processor or circuitry configured to perform logical operations. The input device 204 can be, for example, a pointing device, such as a mouse or trackball, a microphone, a touch screen, and/or a keyboard. The output device 206 can be, for example, a display device, such as a liquid crystal display (LCD) screen, a printer, and/or audio speakers. The memory device 208 can be any type of data storage device, including, for example, volatile memory and/or non-volatile memory, and can be fixed within the system 200 or can be removable. The system 200 may also include a communications device 210, such as a data bus, a transmitter, a receiver, a transceiver, a network connection device, and/or a wireless connection device, for transmitting data to and/or receiving data from outside the system. For example, the system 200 can be embodied in a general purpose or application specific computer.

Referring to FIGS. 3 and 10, in some embodiments, operation of the system 200 may occur in conjunction with execution by the processing device 202 of instructions stored, say, in the memory device 208. The instructions could include instructions that cause the processing device 202 to possess, for example, the functionality of the area identification module 102, the data identification module 104, and the data presentation module 106 (such that the system 100 is the functional equivalent of the area characterization system 200).

Referring to FIGS. 1-3 and 10, the area characterization system 200 can cause information, such as the geographic region 10, to be presented, for example, via the output device 206. Areas of interest could be created (i.e., identified) using the input device 204, for example, by specifying the vertices 11 that will define the area of interest 12 using a mouse, or could be selected, for example, by typing the name of a pre-defined area with a keyboard.

Referring to FIG. 11, therein is shown an area characterization system 200a configured in accordance with another exemplary embodiment. The system 200a includes several processing devices 202a-c that are respectively utilized in accomplishing the functionalities of the modules 102-106. The processing devices 202a-c can be distributed, for example, between or among separate computers or apparatuses 240a-c to invoke the respective functionalities of the modules 102-106, which computers or apparatuses need not be physically located together as long as communication exists between the different apparatuses/modules. Each of the separate apparatuses 240a-c can include a respective memory device 208a-c, and these memory devices can maintain, for example, the map database 108, the pre-defined area database 110, and/or the descriptor database 112, etc.

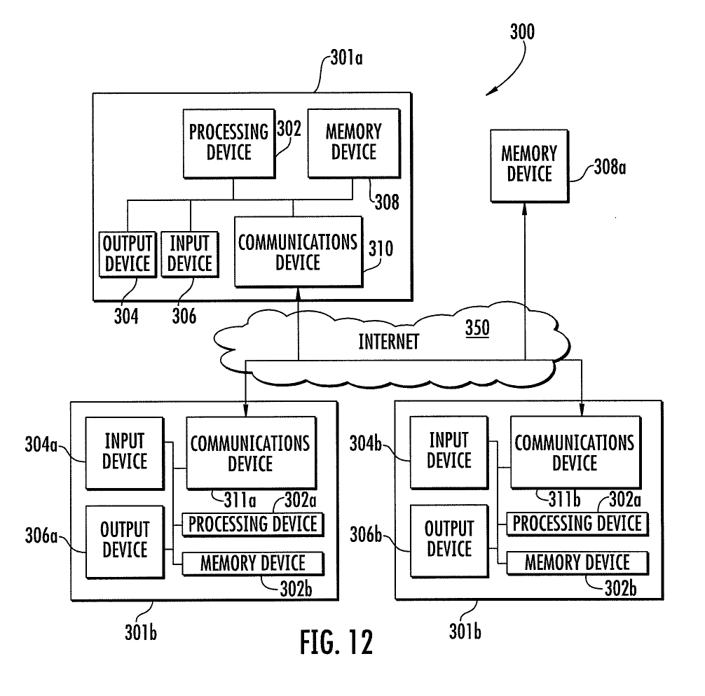

Referring to FIG. 12, therein is shown a block diagram schematically representing an area characterization system 300 configured in accordance with another exemplary embodiment. The system 300 can include a central processing terminal 301a and one or more user terminals 301b. The central processing terminal 301a can include, for example, a processing device 302, a memory device 308, and a communications device 310. Each respective user terminal 301b can include an input device 304a-b and an output device 306a-b, as well as a communications device 311a-b. The communications devices 310 and 311a-b allow the central processing terminal 301a and the user terminals 301b to communicate with one another, for example, through a network, such as the Internet 350. In one embodiment, the user terminal 301b may display a user interface, such as a map available from a web site provided over the Internet 350 by the central processing terminal 301a, via a LCD screen of the output device 306a. The data comprising the web site may, for example, be contained in the memory device 308, and the web site may be generated through operation of the processing device 302 and transmitted via the communications device 310. Using the input device 304a, the user may identify an area of interest, either by selecting a pre-defined area or by creating a new area.

The central processing terminal 301a may receive, for example, through the Internet 350 and via the communications device 310, the data defining the area of interest, and can then initiate a search for data sets pertaining to the identified area. The search can be directed to data stored in the memory device 308 associated with the central processing terminal 301a, in a separate memory device 308a, or elsewhere. Any of these memory devices 308, 308a may contain data sets specifically associated with one or more previously-defined areas of interest, or may contain data sets that are simply geo-tagged. In any event, the central processing terminal 301a can then distill, categorize, summarize, etc. the data sets collected during the search such that the data sets can be presented in a comprehensible form at the output device 306a of the user terminal 301b.

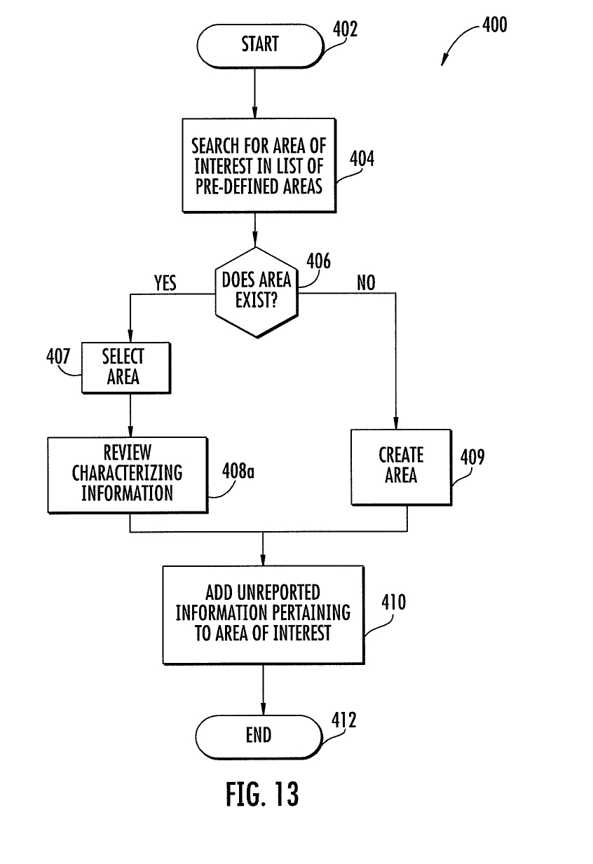

Referring to FIG. 13, therein is shown a flowchart representing the operation of a method 400 configured in accordance with an exemplary embodiment. For example, the method 400 may be carried out through the use of an area characterization system 100, 200, 200a, 300 as depicted in FIGS. 3 and/or 10-12. After starting at Block 402, a user can search, at Block 404, for a desired area of interest (e.g., a particular geographic area) from amongst various pre-defined areas. At Block 406, a determination can be made as to whether the desired area of interest is present in the list of pre-defined areas. If such area has been previously defined and does exist in the list, then at Block 407 the user can identify the area of interest by selecting the area from the list, which will cause information characterizing that identified area to be presented. At Block 408, a user can review the area-characterizing information associated with the identified area of interest. If the user has any information regarding the area of interest that would supplement the information already associated with the area of interest, the user can add that unreported information, at Block 410 to the information already associated with the identified area.

If at Block 406 it is determined that a particular area of interest does not exist in the list of pre-defined areas, then at Block 409 the user can identify the area of interest by creating the area. Thereafter, at Block 410, the user may specify data to be associated thereafter with the newly-identified area. At this point, data could also be gathered (perhaps automatically) and associated with the newly-identified area. The method 400 could then end at Block 412, this ending constituting the end of a specific user “session.” After Block 412, the same or a different user could then initiate the method 400 in order to review or modify the information entered in previous sessions or to add new information, including identifying new areas of interest.

In the method 400, all of the information that was associated with pre-defined areas of interest could be generated through manual inputs. In cases where multiple users have access to a common list of pre-defined areas, users can aggregate their knowledge of pre-defined areas in order to increase the total amount of information available for any given identified area. Therefore, embodiments of the system can act to assure that the results of a prior user's session persist in the future. Embodiments of such a method, and embodiments of associated systems, could be useful, for example, in providing information to persons relocating or interested in purchasing real estate.

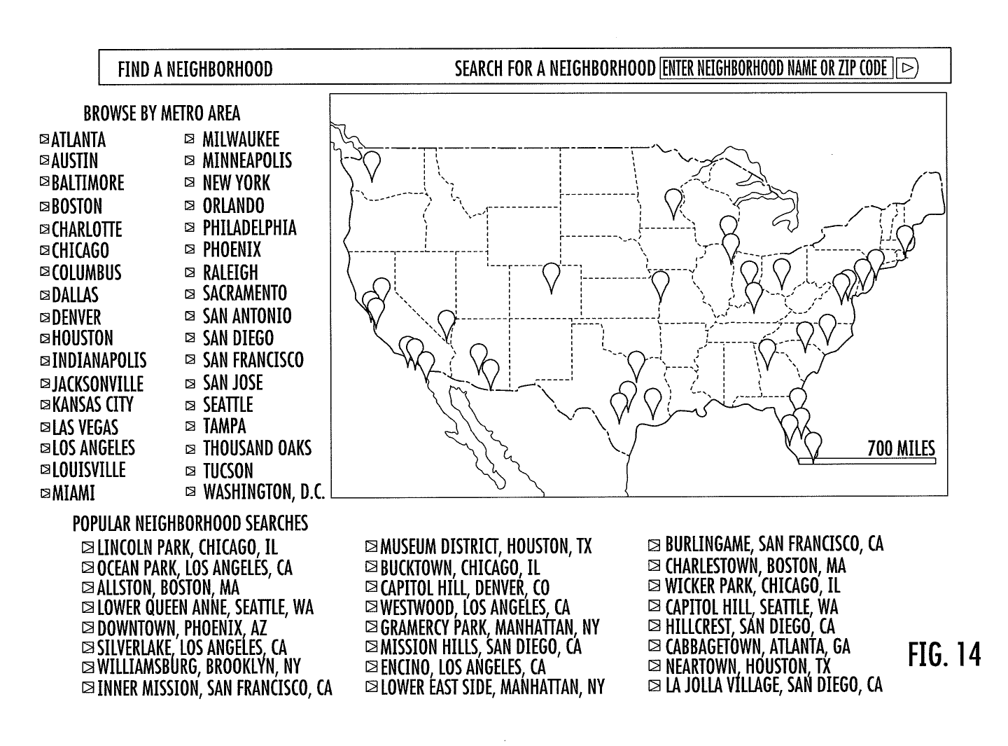

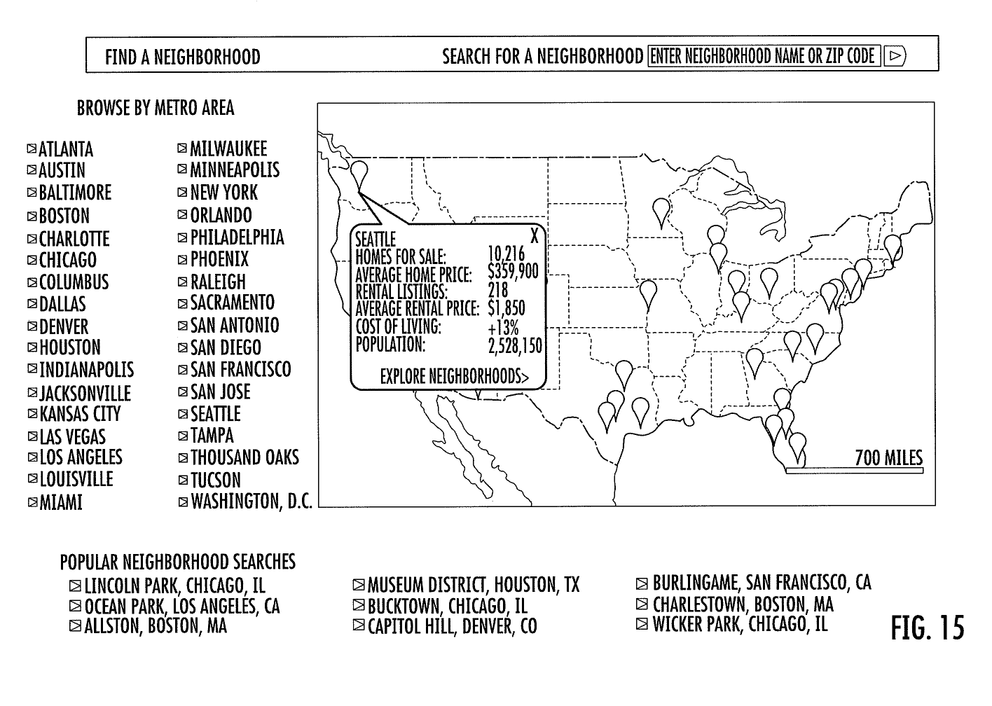

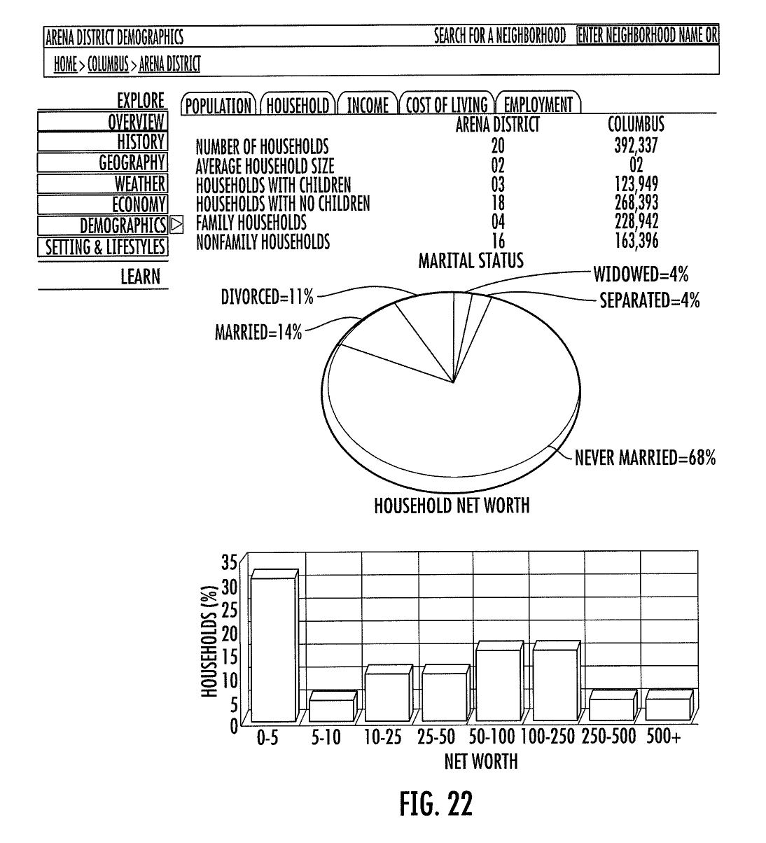

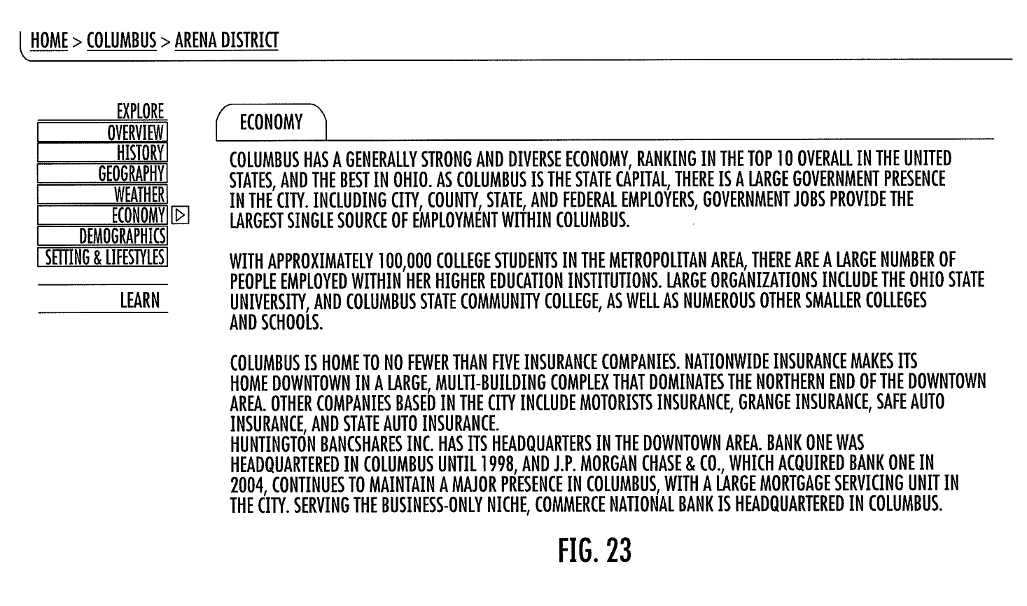

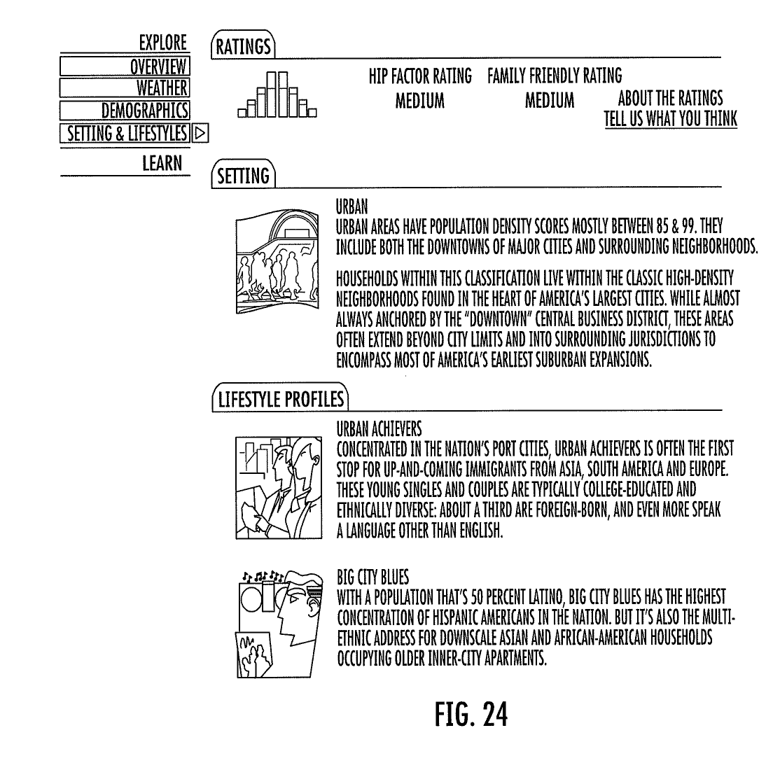

Referring to FIGS. 14-31, therein are shown outputs produced during the operation of an area characterization system configured in accordance with an exemplary embodiment, for example, as shown in FIGS. 3 and/or 10-12. In FIG. 14, an initial screen displays a map indicating a region, the United States, and a list of sub-regions, those being various metro areas around the country. The metro areas are presented both graphically and textually, and by pointing to any metro area indicator with, for example, a mouse-driven cursor, some general information regarding the metro area is presented (FIG. 15). In the illustrated case, the cursor has been placed over the “Seattle” metro area.

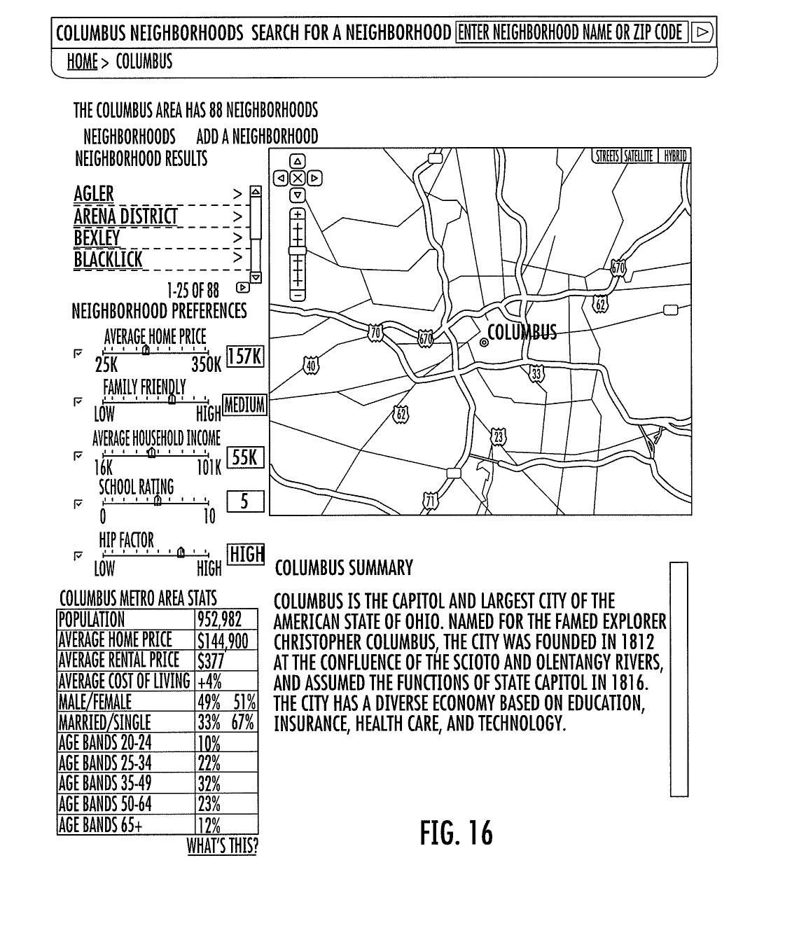

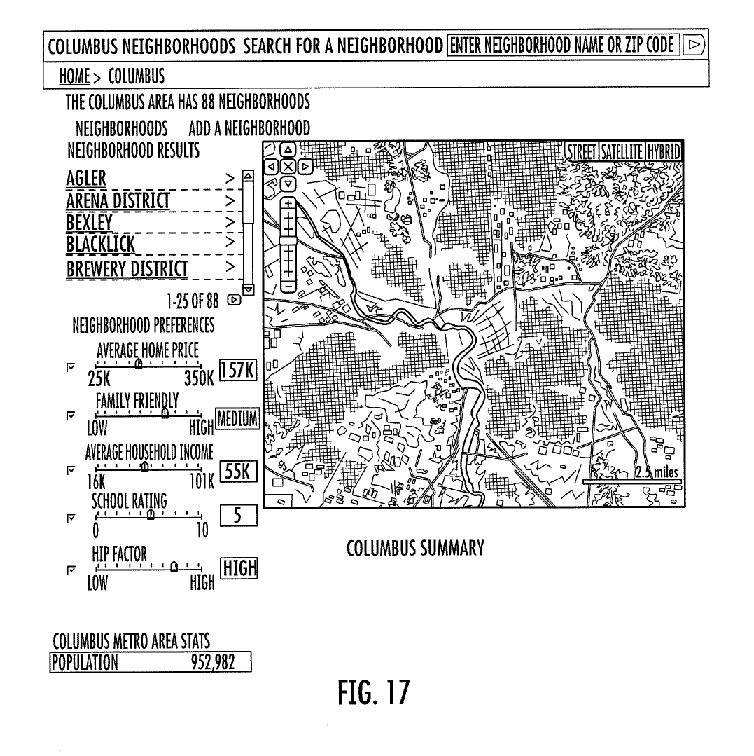

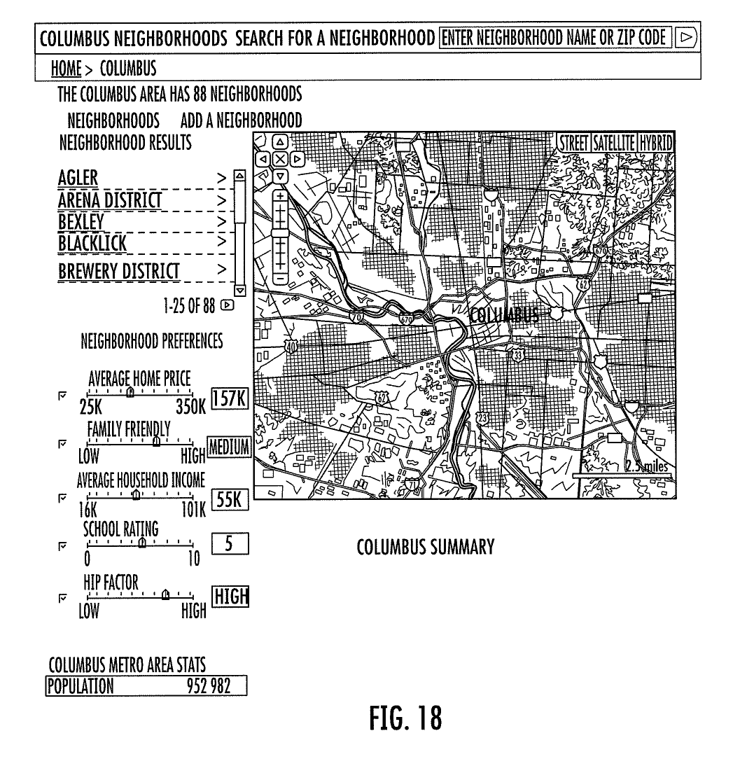

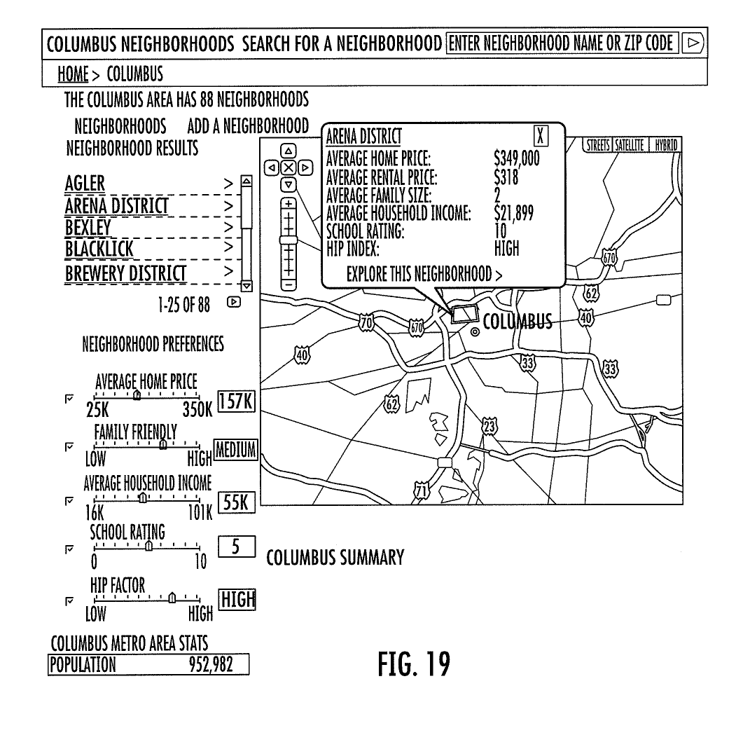

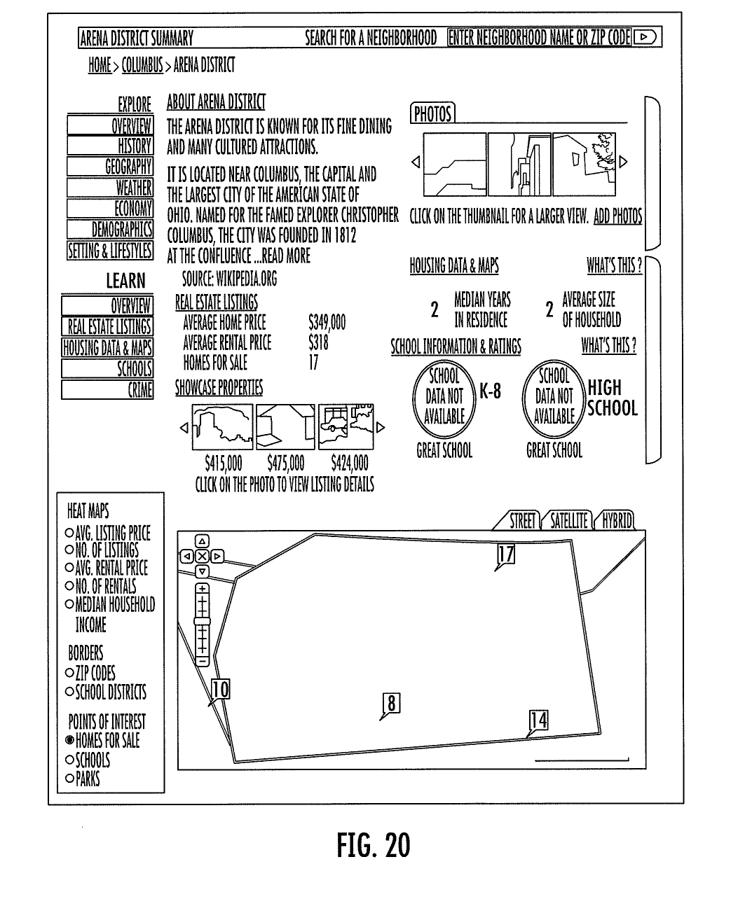

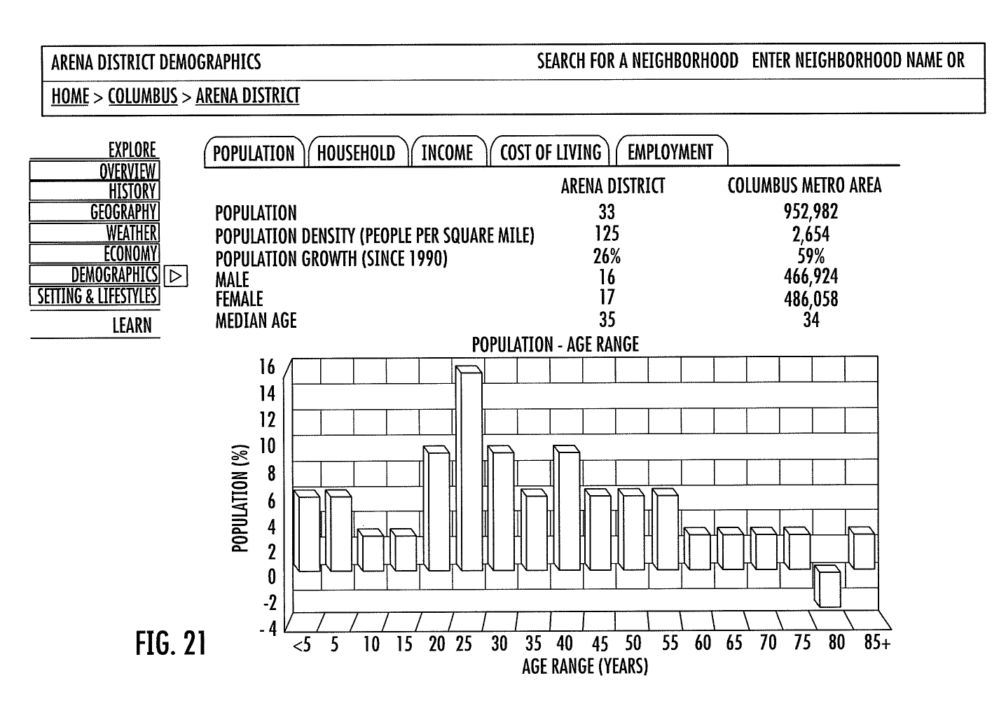

Actual selection of the metro-area (again, for example, with a mouse) provides a more detailed overview of the selected metro area, as illustrated in FIG. 16. In the figure, the “Columbus” metro area has been selected. The more detailed overview can include a summary description of the selected metro area, demographic data, a map of the metro area, and a list of pre-defined areas or “neighborhoods” previous created and considered to be associated with the selected metro area (in the figure, “Agler”, “Arena District”, Bexlex” . . . ). It is noted that the map shown in FIG. 16 is a street map, but that other types of maps, such as a satellite images (FIG. 17) and hybrid street map/satellite images (FIG. 18), may additionally be utilized to provide further information.

From the list of neighborhoods, a specific neighborhood can be selected, for example, with a mouse or other pointing device. In the figure, the “Arena District” has been selected for more detailed examination. Selection of a neighborhood can result in the display of the neighborhood in the metro area map (FIG. 19), such that a user might note the location of the identified area within the more general metro area. In conjunction with the display of the identified neighborhood, a brief description of the neighborhood can be presented, including information such as the average home price in the neighborhood, the average family size, etc. The user can be provided with an option to examine the neighborhood in more detail (e.g., by selecting the “Explore this neighborhood” option).

If a user opts to more closely examine a specific neighborhood, a display providing more detailed information can be presented (FIG. 20). The more-detailed information can include a description of the area, a more detailed map of the neighborhood, school system information, information regarding average home prices and family sizes, home listings, etc. This more-detailed display can link to even further details, presented either textually, graphically, or both, regarding the neighborhood (for example, via the tabs on the left of FIG. 20, leading to the respective displays in FIGS. 21-24).

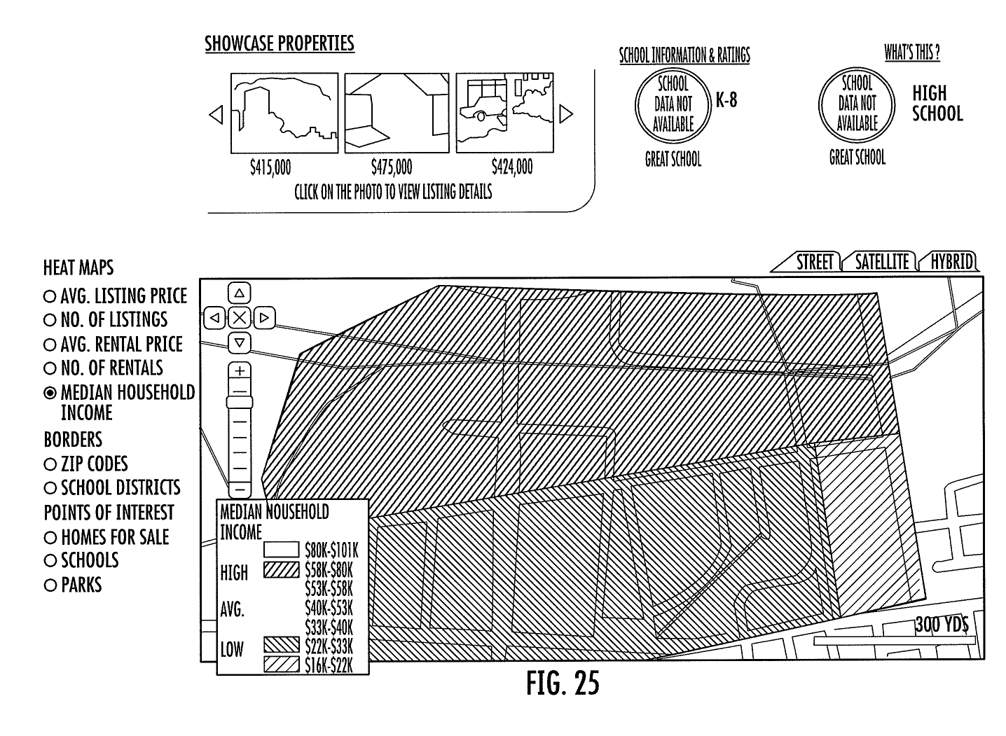

As demonstrated in FIG. 25, the map provided in the more detailed neighborhood display can be used to graphically present various types of neighborhood information. For example, by selecting an appropriate option, the map can be used to show a contour or “heat” plot of listing price, median household income, etc. as a function of location within the neighborhood.

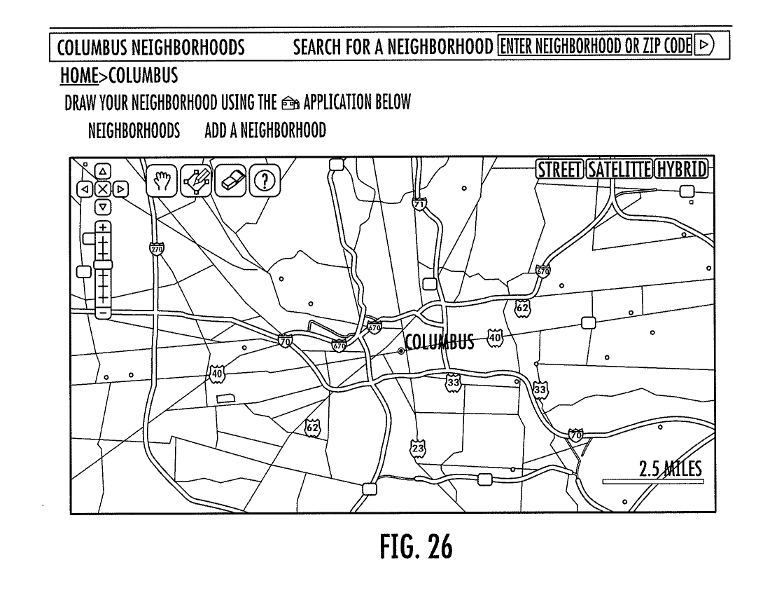

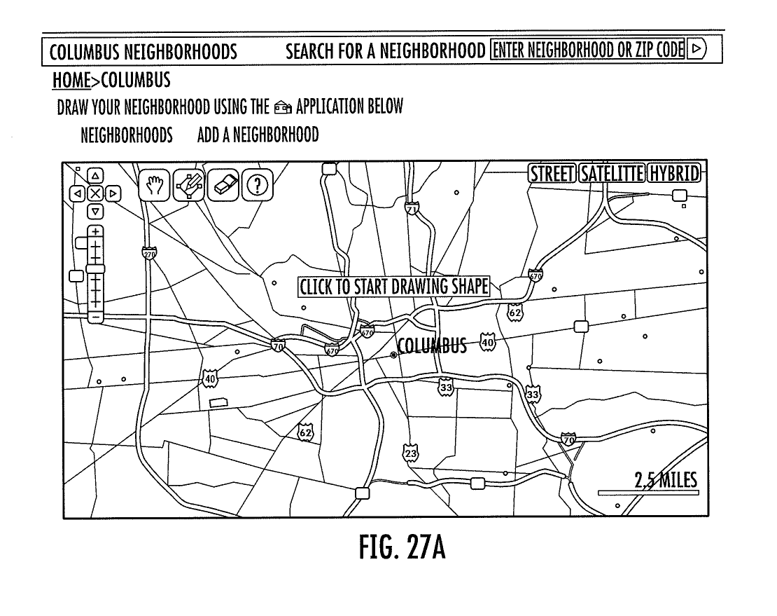

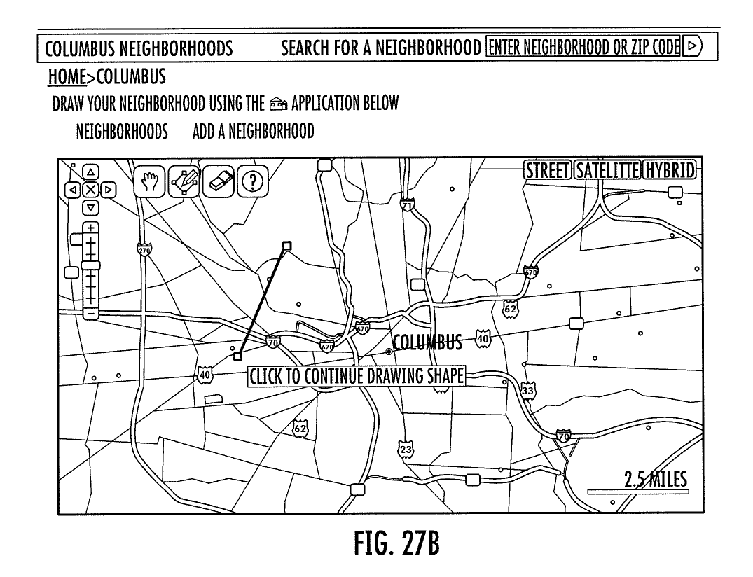

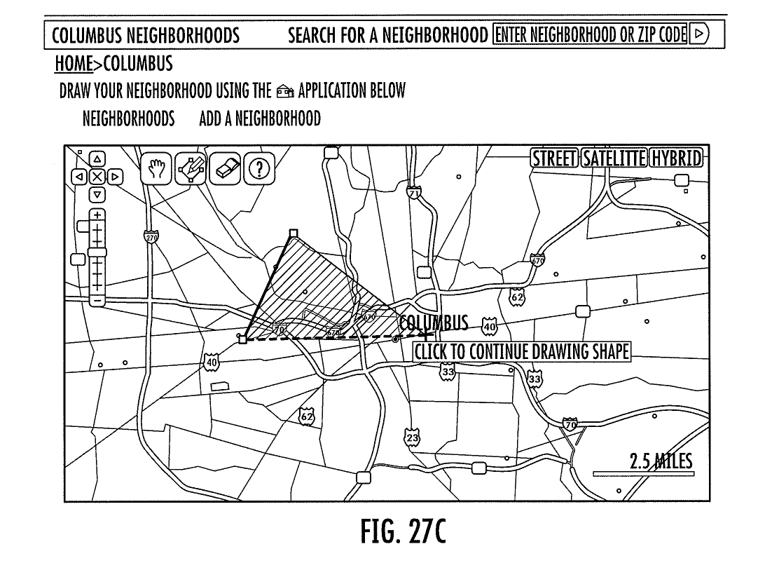

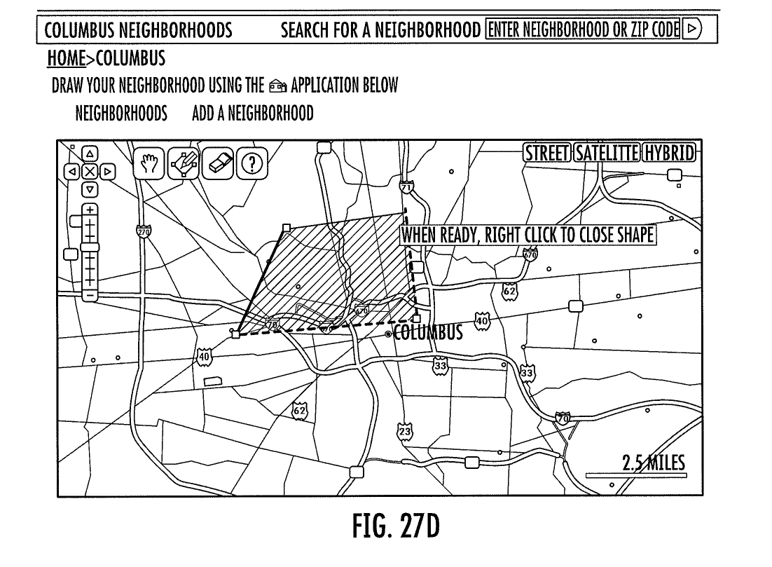

Returning to FIGS. 16-18, a user may be presented with several tabs towards the top of the display labeled “Neighborhoods” and “Add a Neighborhood”, respectively. By choosing “Add a Neighborhood”, a user can be directed to an application that allows the user to newly-create a customized area (FIG. 26). The application may present a graphical map, and a user may be prompted to select a “drawing tool” from the display. Thereafter, the user may be prompted to click on the map in order to start drawing (FIG. 27A), the click placing a vertex on the map. Each subsequent click can act to place further vertices on the map, thereby defining first a line (FIG. 27B) and then a triangular area (FIG. 27C), and so on (FIG. 27D).

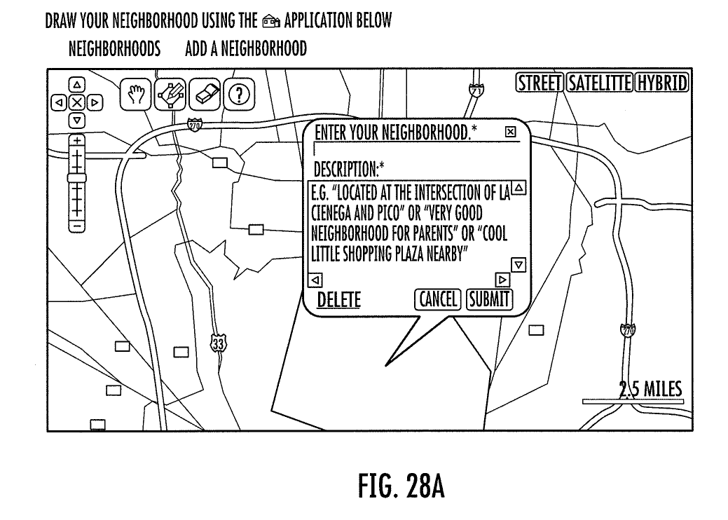

When enough vertices have been placed to potentially form a two-dimensional area, the user may also be prompted to selectively “close” the area being created (for example, by striking a certain key on a mouse or keyboard), at which time the user may be asked to provide a name for the newly-created area/neighborhood (FIG. 28A). The name can be entered into a graphical user interface constructed for accepting such information (FIG. 28B, in which example the neighborhood has been named “Balaishis’). The user may also be prompted to provide other information about the neighborhood in order to describe or categorize the neighborhood.

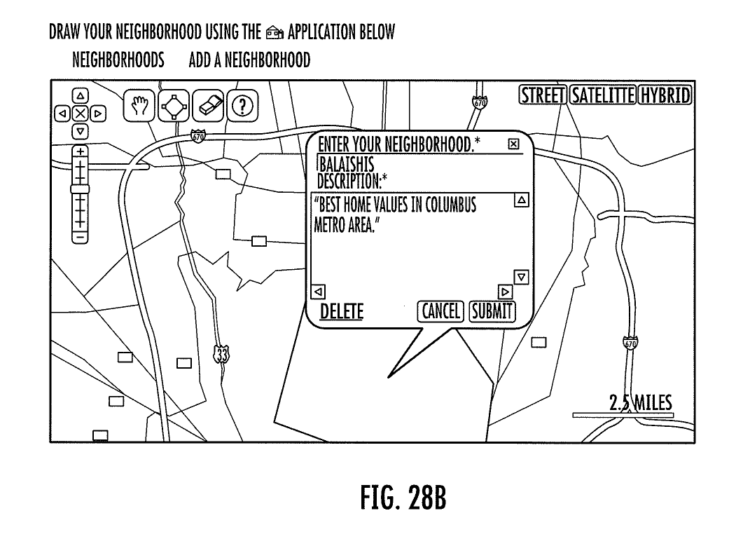

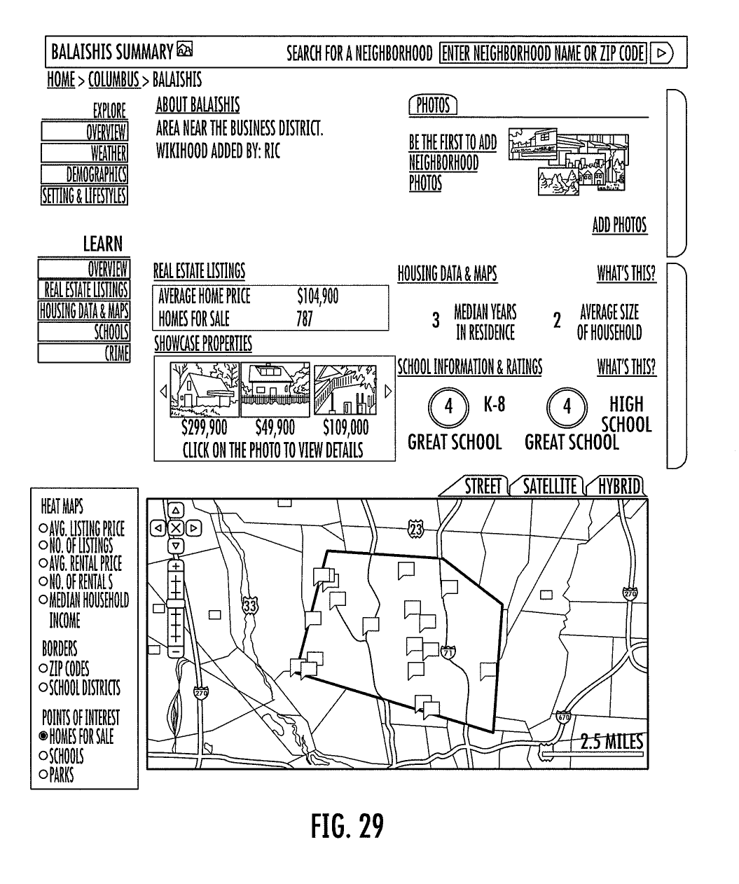

Once the neighborhood has been created, the user can be presented with an overview of the neighborhood, the overview being based on and including existing or previously collected data pertaining to the identified neighborhood (FIG. 29). This information could include, for example, at least any or all of the information provided with respect to previously-defined neighborhoods (FIGS. 21-24), which previously-defined neighborhoods may coincide with the newly-defined neighborhood to some extent. An example of detailed weather information gathered regarding the newly-created neighborhood “Balaishis” is shown in FIG. 30.

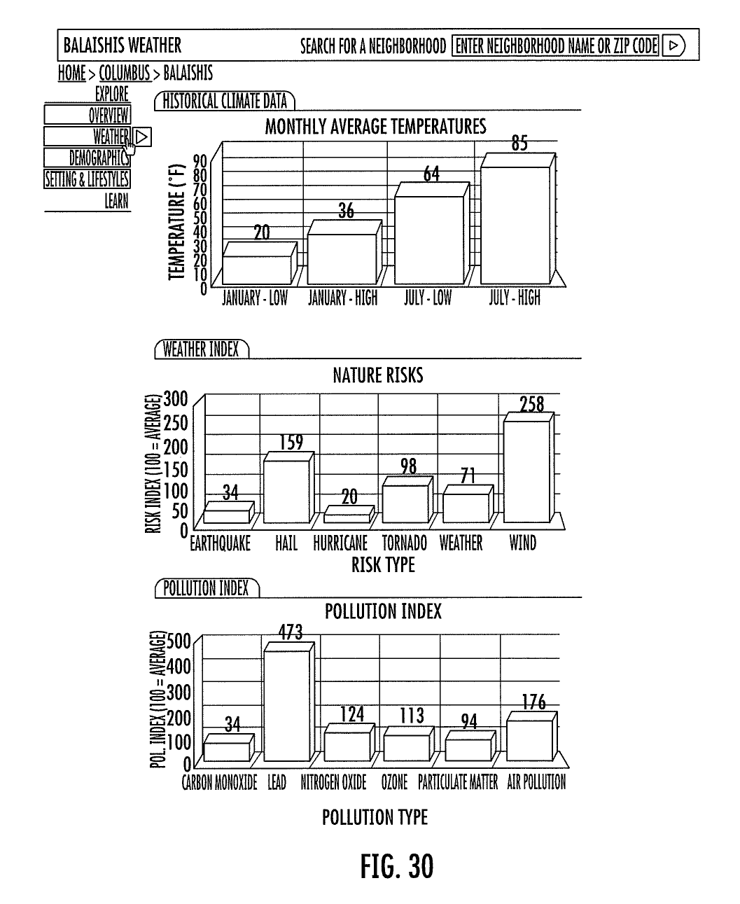

Once a neighborhood has been created, the neighborhood can be added to the list of neighborhoods related to the metro area being investigated. For example, in the illustrated case, review of FIG. 31 shows that the neighborhood “Balaishis” has been added to the list of neighborhoods related to the Columbus metro area. This neighborhood can then be selected and reviewed by other users interested in the Columbus metro area.

At various points, either for the pre-defined neighborhoods or the newly-created neighborhoods (which, in subsequent user sessions may act as pre-defined neighborhoods), users may be prompted provide input. For example, a user may be asked to add information about a neighborhood, or may be asked to comment on the information already provided. In other embodiments, users may be asked to comment on the validity of the boundaries of the neighborhood in light of the description. For example, the user may be asked to modify a previously-specified boundary, say, in the manner shown in FIGS. 32-34. Systems can be put in place to determine which input is or is not reliable, and the data presented can be a function of the amount of input received in favor of or opposed to the data. For example, if a first user specifies a certain boundary configuration, and subsequent users consistently specify a different configuration, the original boundary configuration can be disregarded.

As described above and as will be appreciated by one skilled in the art, embodiments of the present invention may be configured as a system, an apparatus, or a method. Accordingly, embodiments of the present invention may be comprised of various means including entirely of hardware, entirely of software, or any combination of hardware and software. Furthermore, embodiments of the present invention may take the form of a computer program product including a computer-readable storage medium having computer-readable program instructions (e.g., computer software) embodied in the storage medium, e.g., memory device 208. Any suitable computer-readable storage medium may be utilized including non-volatile memory devices such as hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processing device 202, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, while the area identification module 102, the data aggregation module 104, and the data presentation module 106 have been described as having certain respective functionalities, it is noted that the extent of each module's functionality can be altered such that the preceding or subsequent module may incorporate some of the functionality attributed to the module at issue. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of specifying a boundary for an area, said method comprising:
presenting a graphical geographic representation;
receiving a first input from a first user specifying a first configuration of a boundary of a geographic area relative to the graphical geographic representation;
receiving a second input from a second user specifying a second configuration of the boundary relative to the graphical geographic representation; and
determining a particular configuration of the boundary based at least partially on the first and second inputs.

2. The method of claim 1, wherein said receiving a first input includes receiving user input establishing an area of arbitrary configuration.

3. The method of claim 2, wherein said receiving user input establishing an area of arbitrary configuration includes receiving user input creating an area of arbitrary configuration that is legally undetermined.

4. The method of claim 2, wherein said receiving a second input includes receiving a user input modifying the boundary of the established arbitrary area.

5. The method of claim 1, wherein said determining a particular configuration of the boundary includes spatially averaging the first and second configurations.

6. The method of claim 1, wherein said receiving a second input from a second user includes respectively receiving multiple inputs from multiple users, each input regarding a respective configuration of the boundary, and wherein said determining a particular configuration of the boundary includes iteratively determining a particular configuration of the boundary based at least partially on each subsequently received input and any previously received inputs.

7. The method of claim 1, further comprising automatically compiling data characterizing an area defined by the particular configuration of the boundary.

8. The method of claim 1, further comprising storing the first configuration of the boundary and graphically presenting the first configuration of the boundary prior to said receiving the second input regarding the second configuration of the boundary.

9. The method of claim 1, further comprising graphically presenting the first and second configurations of the boundary in a graphical geographic representation so as to allow comparison therebetween.

10. The method of claim 1, further comprising graphically presenting the particular configuration of the boundary in a graphical geographic representation.

11. The method of claim 1, wherein said presenting a graphical geographic representation includes presenting with a processing device a graphical geographic representation, said receiving a first input from a first user specifying a first configuration of a boundary of a geographic area relative to the graphical geographic representation includes receiving with the processing device a first input from a first user specifying a first configuration of a boundary of a geographic area relative to the graphical geographic representation, said receiving a second input from a second user specifying a second configuration of the boundary relative to the graphical geographic representation includes receiving with the processing device a second input from a second user specifying a second configuration of the boundary relative to the graphical geographic representation, and said determining a particular configuration of the boundary based at least partially on the first and second inputs includes determining with the processing device a particular configuration of the boundary based at least partially on the first and second inputs.

12. A computer-readable storage medium that stores computer-readable instructions that, when executed by a computer, cause the computer to carry out a method comprising:
presenting a graphical geographic representation;
receiving a first input from a first user specifying a first configuration of a boundary of a geographic area relative to the graphical geographic representation;
receiving a second input from a second user specifying a second configuration of the boundary relative to the graphical geographic representation; and
determining a particular configuration of the boundary based at least partially on the first and second inputs.

13. The computer-readable storage medium of claim 12, wherein said receiving a first input includes receiving user input establishing an area of arbitrary configuration.

14. The computer-readable storage medium of claim 13, wherein said receiving user input establishing an area of arbitrary configuration includes receiving user input creating an area of arbitrary configuration that is legally undetermined.

15. The computer-readable storage medium of claim 13, wherein said receiving a second input includes receiving a user input modifying the boundary of the established arbitrary area.

16. The computer-readable storage medium of claim 12, wherein said determining a particular configuration of the boundary includes spatially averaging the first and second configurations.

17. The computer-readable storage medium of claim 12, wherein said receiving a second input from a second user includes respectively receiving multiple inputs from multiple users, each input regarding a respective configuration of the boundary, and wherein said determining a particular configuration of the boundary includes iteratively determining a particular configuration of the boundary based at least partially on each subsequently received input and any previously received inputs.

18. The computer-readable storage medium of claim 12, wherein said computer-readable instructions stored therein are further configured, when executed by a computer, to cause the computer to automatically compile data characterizing an area defined by the particular configuration of the boundary.

19. The computer-readable storage medium of claim 12, wherein said presenting a graphical geographic representation includes presenting with a processing device a graphical geographic representation, said receiving a first input from a first user specifying a first configuration of a boundary of a geographic area relative to the graphical geographic representation includes receiving with the processing device a first input from a first user specifying a first configuration of a boundary of a geographic area relative to the graphical geographic representation, said receiving a second input from a second user specifying a second configuration of the boundary relative to the graphical geographic representation includes receiving with the processing device a second input from a second user specifying a second configuration of the boundary relative to the graphical geographic representation, and said determining a particular configuration of the boundary based at least partially on the first and second inputs includes determining with the processing device a particular configuration of the boundary based at least partially on the first and second inputs.

20. An apparatus comprising:
a processing device configured to generate a graphical geographic representation, to receive a first input from a first user specifying a first configuration of a boundary of a geographic area relative to the graphical geographic representation, to receive a second input from a second user specifying a second configuration of the boundary relative to the graphical geographic representation, and to determine a particular configuration of the boundary based at least partially on the first and second inputs.
